(19) United States
(12) Patent Application Publication
(10) Pub. No.: US 2012/0247631 A1
(43) Pub. Date: Oct. 4, 2012

(54) TRACTION TIRE TREAD FOR OFF-ROAD VEHICLE

(76) Inventor: Timothy Michael Rooney, Munroe Falls, OH (US)

(21) Appl. No.: 13/074,139

(22) Filed: Mar. 29, 2011

(51) Int. Cl. B60C 11/117

(52) U.S. Cl. 152/209.17

(57) ABSTRACT

An off-road tire tread for a tire includes a series of cavities extending into the tread surface, each cavity defined by sidewalls extending from a tread surface to an inclined bottom cavity surface, the inclined bottom cavity surface extending from a relatively deep leading cavity end to a relatively shallow trailing cavity end. The cavities are directionally oriented to operationally initiate contact with a ground surface at the leading cavity end and form a repeating circumferential pattern along a circumferential extent of the tread surface. The tire tread further may include one or more lug protrusions between each of the cavities extending outward from the tread surface.

### FIELD OF THE INVENTION

The invention relates generally to a tire tread for off-road vehicles and, in particular, to a tire tread providing suitable traction on an off-road particulate surface such as sand.

### BACKGROUND OF THE INVENTION

Traction is important in off-road vehicle usage and the tire tread performance of such vehicles is instrumental in achieving a satisfactory level of traction. Achieving satisfactory traction from a vehicle's tire tread on an off-road particulate surface such as sand is particularly problematic. Because sand has almost no cohesion and consists of large rounded particles, most lugged tires dig into the sand and the increase in motion resistance due to the sinking of the tire into the sand tends to overwhelm forward thrust.

### SUMMARY OF THE INVENTION

In one aspect of the invention, an off-road tire tread for a tire includes a series of cavities extending into the tread surface, each cavity defined by sidewalls extending from a tread surface to an inclined bottom cavity surface, the inclined bottom cavity surface extending from a relatively deep leading cavity end to a relatively shallow trailing cavity end. The cavities are directionally oriented to operationally initiate contact with a ground surface at the leading cavity end.

In another aspect, each cavity has a quadrilateral sectional configuration and the cavities form a repeating circumferential pattern along a circumferential extent of the tread surface.

Adjacent cavities may be spaced apart to have a centerline to centerline spacing between 3 and 5 inches; each cavity having a depth at the leading cavity end between 0.4 and 0.6 inches according to further aspects of the invention.

In yet a further aspect, the tire tread further includes at least one lug protrusion between each of the cavities, the lug protrusion having a rectangular configuration in section having a width between 0.25 and 0.625 inches; a height of between 0.25 and 0.375 inches; and a length between 1 and 3 inches.

### DEFINITIONS

The following definitions are applicable to the present disclosure and are used consistently as defined below:

“Apex” means an elastomeric filler located radially above the bead core and between the plies and the turnup ply.

“Aspect Ratio” means the ratio of its section height to its section width.

“Bead” means that part of the tire comprising an annular tensile member wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17 degrees to 27 degrees with respect to the equatorial plane of the tire.

“Casing” means the carcass, belt structure, beads, sidewalls, and all other components of the tire excepting the tread and undertread. The casing may be unvulcanized rubber or previously vulcanized rubber to be fitted with a new tread.

“Chafers” refers to narrow strips of material placed around the outside of the bead to protect cord plies from the rim, distribute flexing above the rim, and to seal the tire.

“Chipper” refers to a narrow band of fabric or steel cord located in the bead area whose function is to reinforce the bead area and stabilize the lower sidewall

“Circumferential” means lines or directions extending along the perimeter of the surface of the annular tread perpendicular to the axial direction.

“Cord” means one of the reinforcement strands of which the plies in the tire are comprised.

“Lateral” means an axial direction.

“Ply” means a continuous layer of rubber-coated parallel cords.

“Radial” and “radially” mean directions radially toward or away from the axis of rotation of the tire.

“Radial Ply Tire” means a belted or circumferentially-restricted pneumatic tire in which the ply cords which extend from bead to bead are laid at cord angles between 65 degrees and 90 degrees with respect to the equatorial plane of the tire.

“Section Height” means the radial distance from the nominal rim diameter to the outer diameter of the tire at its equatorial plane.

“Section Width” (“SW”) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Shoulder” means the upper portion of sidewall just below the tread edge, tread shoulder or shoulder rib means that portion of the tread near the shoulder.

“Sidewall” means that portion of a tire between the tread and the bead.

“Tread” means that portion of the tire that comes into contact with the road under normal inflation and load.

“Tread width (TW)” means the arc length of the tread surface in the axial direction, that is, in a plane passing through the axis of rotation of the tire.

### BRIEF DESCRIPTION OF THE DRAWINGS

The invention will be described by way of example and with reference to the accompanying drawings in which:

FIG. 1 is a perspective view of a tire representing the prior art.

FIG. 2 is a front isometric view of a tire having a tread pattern of the invention.

FIG. 3 is a rear isometric view of the tire.

FIG. 4 is a front plan view of the tire.

FIG. 5 is an enlarged fragmentary view of the tire tread.

FIG. 6 is a partial section view showing a deeper part of a tread cavity engaging sand and pushing with the tapered surface of the cavity.

FIG. 7 is a plan view of the cavity footprint pattern.

FIG. 8 as a section view along 8-8 of FIG. 7.

FIG. 9 is a section view along 9-9 of FIG. 7.

FIG. 10 is a plan view of an alternative tread pattern incorporating an array of smaller cavities oriented in an opposite direction.

FIG. 11 is a section view along 11-11 of FIG. 10.

FIG. 12 is a perspective view of an alternative lugged embodiment of a tire incorporating cavities pursuant to the invention.

FIG. 13 is a plan view of a tread portion of the alternative embodiment of FIG. 12.

FIG. 14 is a section view along 14-14 of FIG. 13.

### DETAILED DESCRIPTION OF THE INVENTION

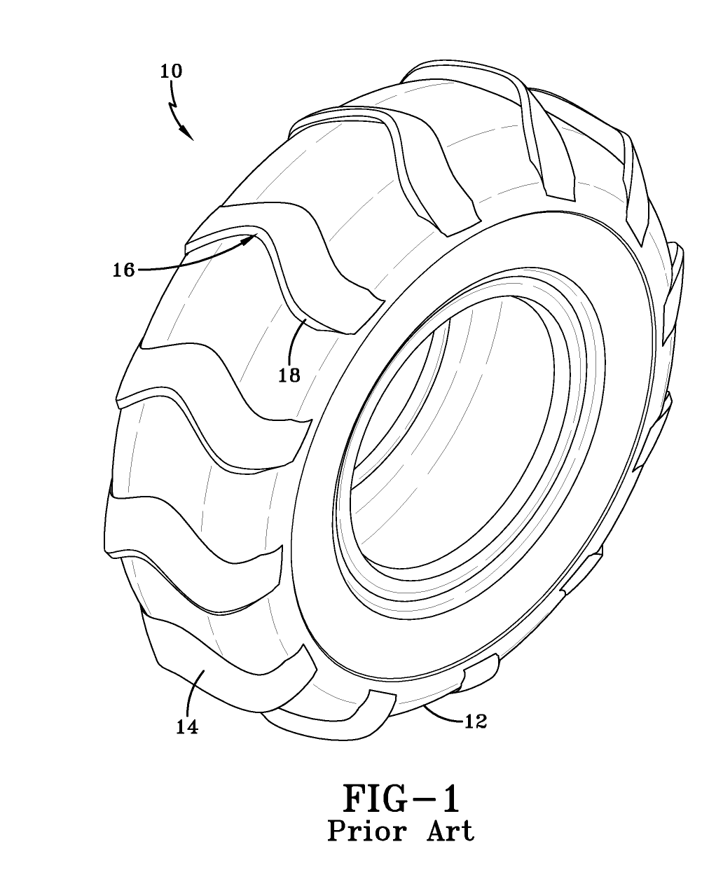

Referring to FIG. 1, a vehicular tire 10 is shown of a type in common use by the industry for sand road applications. The tire 10 has a circumferential tread surface 12 and a direction ribbed lug circumferential pattern extending from surface 12 and consisting of spaced apart curvilinear rib lugs 14. Each of the rib lugs 14 has a leading edge 18 oriented to initiate contact with the ground in a direction of travel and a central lug indentation 16 oriented to scoop the granular ground surface and generate push in the direction of travel. Because sand has almost no cohesion and consists of large rounded particles, typical lugged tires with standard on/off road tread patterns, dig quickly into the sand and although they develop some forward thrust, the increase in motion resistance due to sinkage overwhelms the forward thrust. Consequently, the vehicle sinks until it bogs down. A suitable sand tire must stay on top of the sand and either just roll on top of it or paddle through it. In order to achieve acceptable sand performance, tire tread may be configured to be either totally smooth (lugless), smooth with a single centerline rib or smooth with widely spaced, very thin lugs such as shown at 10 of FIG. 1. However, if so designed, while working acceptably in the sand, the tires cannot be used on any other surface for any length of time due to serious deficiencies in wear (lug degradation), traction (resulting from lug degradation); ride/stability and handling.

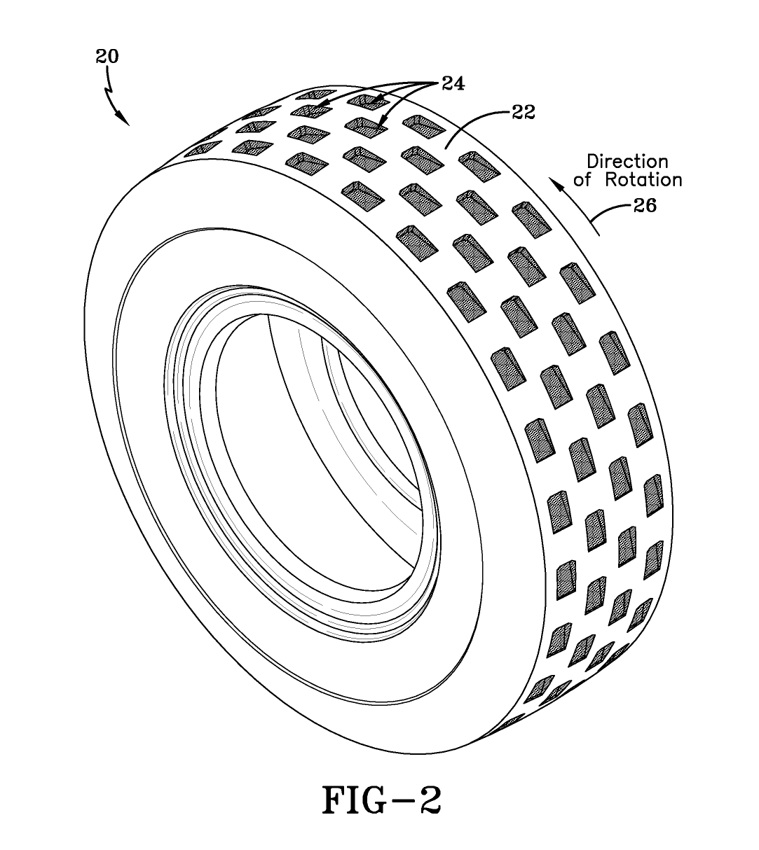

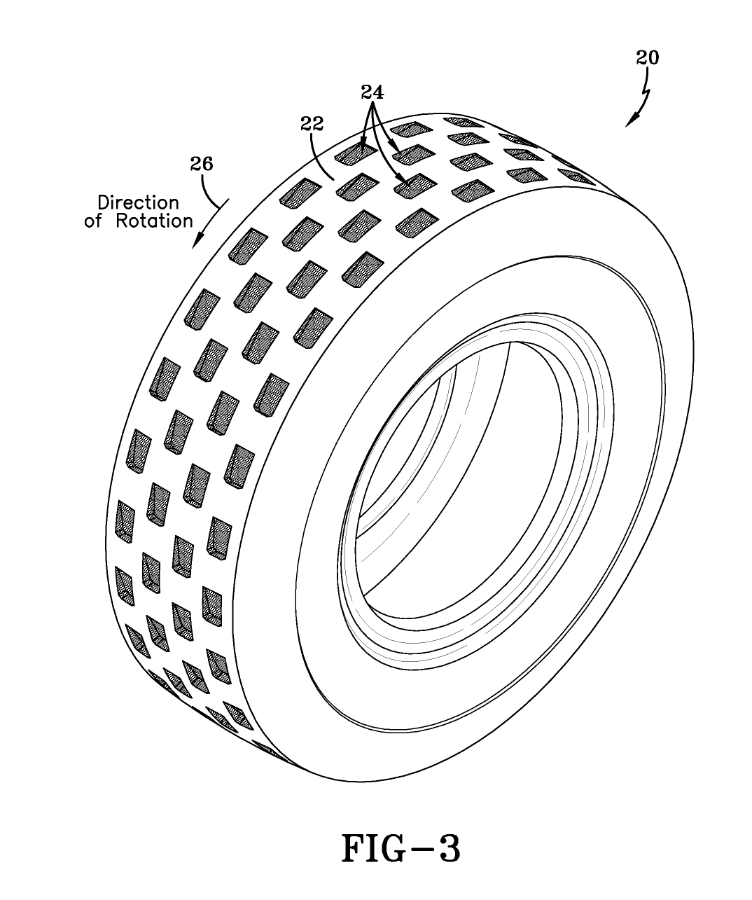

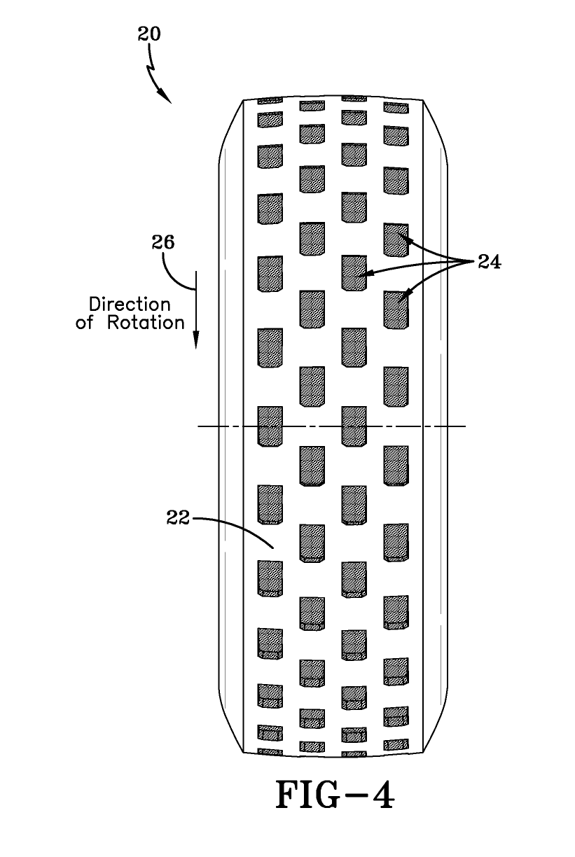

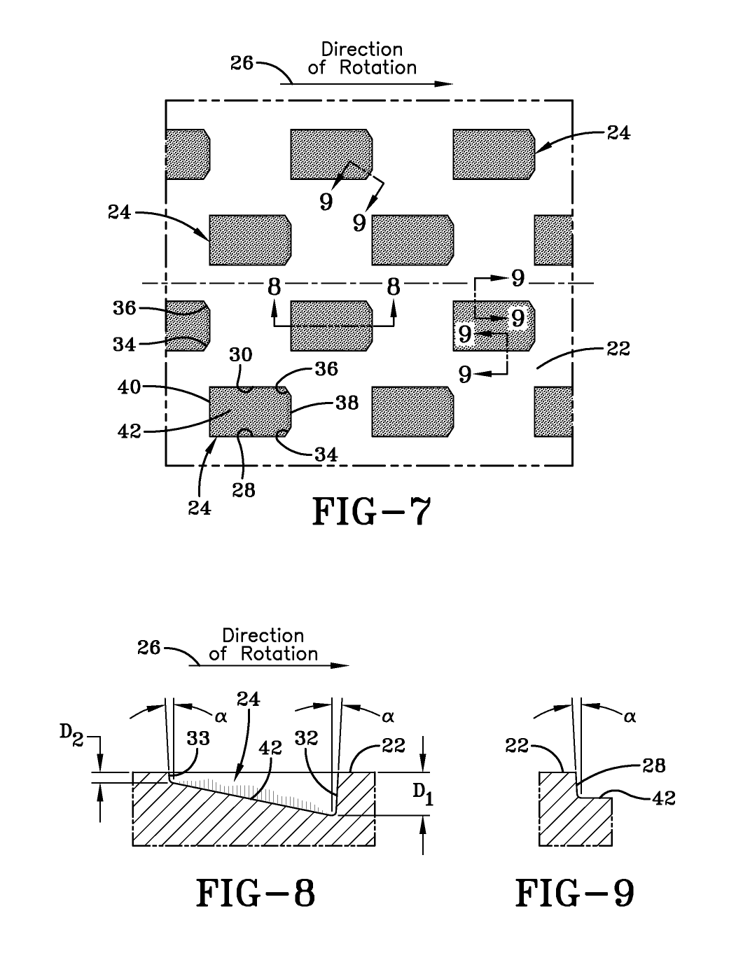

The tread pattern of the invention provides satisfactory performance in sand while maintaining functional performance on other types of surfaces. As shown in FIGS. 2, 3, 4, 5, 6, 7 and 8, the tire 20 is configured having an outer circumferential tread surface 22 in which a circumferential array of cavities 24 extend. The cavities are oriented generally according to a forward direction of travel indicated by rotation arrow 26 as will be explained. Each cavity 24 is of a general rectangular sectional configuration, defined by a pair of cavity sidewalls 28, 30, a forward end wall 32, and a rear end wall 33. At the forward corners of each cavity 24 between each sidewall 28, 30 and the forward end wall 32 is a beveled surface 34, 36. The forward end wall 32 represents the leading end 38 of the cavity 24 and the rearward end wall 33 the trailing end 40. Each cavity 24 extends to a bottom inclined cavity floor surface 42. The inclination of the bottom surface 42 is in a direction opposite to the forward direction of rotation 26 by which each cavity 24 progressively deepens from the rearward trailing end 40 to the leading end 38.

FIG. 6 illustrates the tire 20 rotating against a granular ground surface 54 such as sand. In the forward direction of rotation 26, the leading, deep end 38 of a cavity 24 is filled with sand. Due to the inclination of the bottom surface 42, as each cavity fills, pressure is exerted against the tire at an angle normal to the bottom surface 42 of a cavity as seen by directional arrows 44. The directional angled pressure of sand within the cavity translates in forward thrust/traction to the tire.

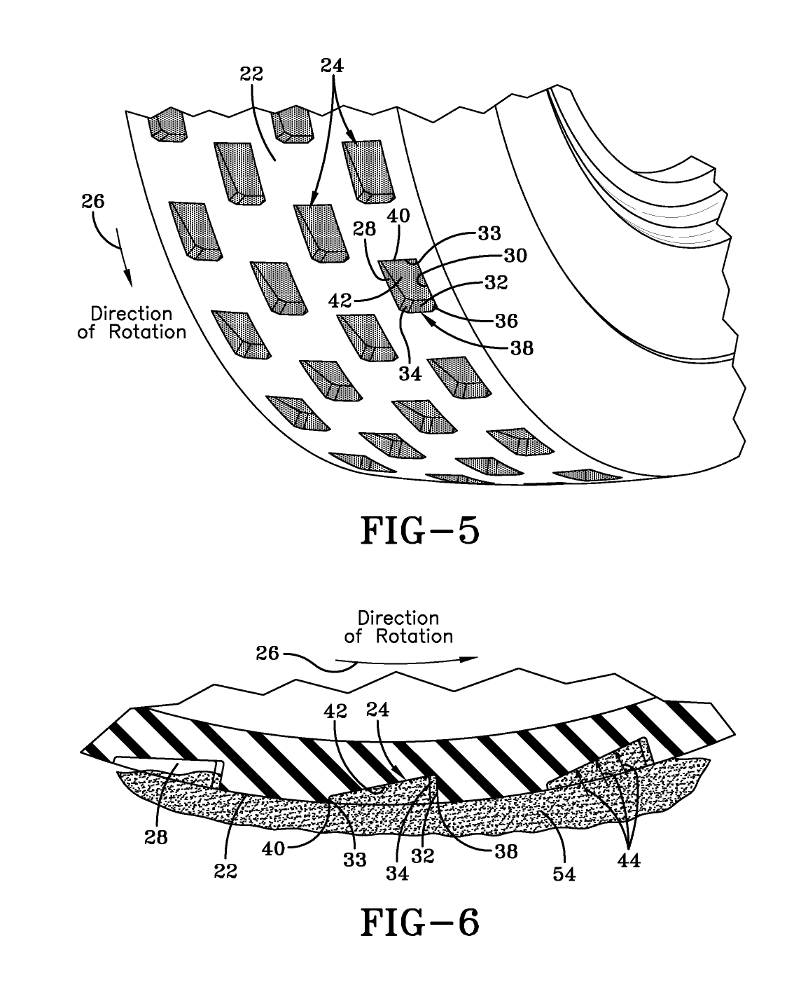

From FIGS. 5, 6, 7, 8, and 9, it is shown that the tread pattern of FIG. 2 thus consists of a series of tapered cavities 24 molded into the smooth tread outer surface 22. As the tire 20 rolls into the sand 54, the deep end 38 of the cavity fills first and the tapered end of the cavity then pushes against the sand to push the tire forward. The cavity 24 confines/traps the sand and applies pressure (p) to it so that shear is maximized as tire slip occurs according to shear=p tan (phi) where p=normal pressure on the soil and phi=the internal angle of friction of the soil. Since there are no lugs extending from surface 22, the tire does not sink into the sand even during slip and therefore motion resistance is minimized. The tire may also be driven on any hard surface with little compromise to wear, ride, or treadwear. Traction on hard and wet surfaces is accordingly adequate. The cavities 24 are nominally 0.5 inches (within a range of 0.4 to 0.6 inches) at the deep end and 0.1 inches (within a range of 0.05 to 0.15 inches) at the shallow end. Total net to gross is approximately 70 percent. It will further be noted from FIG. 8 that each cavity 24 has a taper angle α of between 1 and 5 degrees or approximately 3 degrees on forward and rearward sides 32, 33 and on beveled surfaces 28, 42 as shown in FIG. 9.

It will be appreciated that each cavity 24 may be configured other than rectangular in section if desired so long as each cavity 24 retains a concave tapered configuration. So configured, the cavity enters a sand surface deep cavity end first and allows the front part of the cavity to push on the trapped sand within the cavity to provide locomotion.

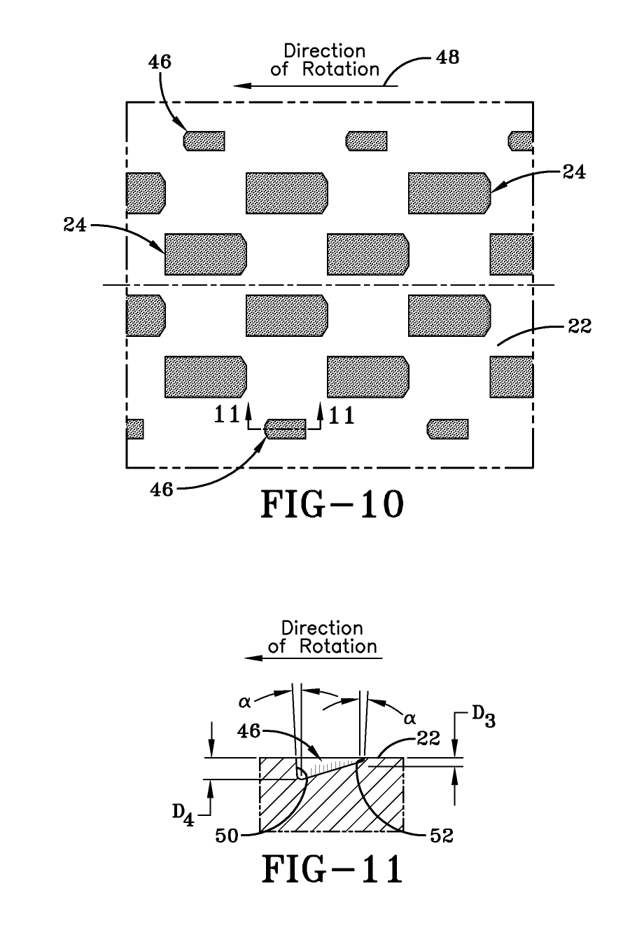

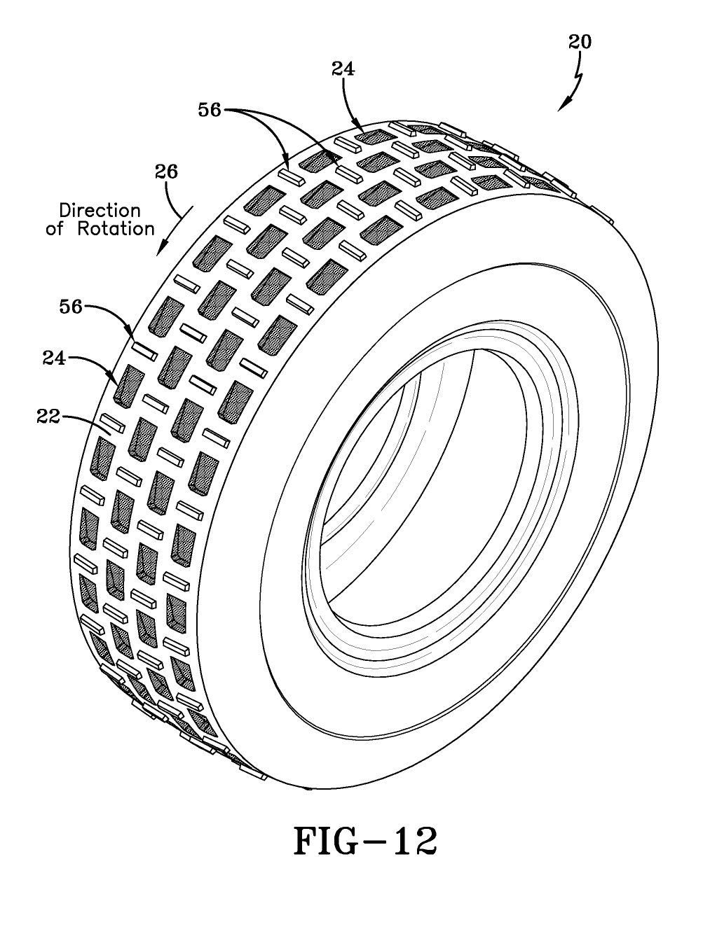

FIGS. 10 and 11 show an alternative tread configuration in which a series of smaller, reversely oriented cavities 46 are placed along outer edges of the tread in order to accommodate traction in a reverse tire rotational direction 48. The smaller cavities 46 are configured as previously described in reference to cavities 34 but oriented in an opposite direction. As such, the smaller cavities 46 do not detract significantly to the performance of the larger cavities 24 in a forward direction but provide enhanced traction by the tire in a reverse rotational direction. FIG. 11 show the dimensional depth D3 as within a range of 0.15 to 0.05 inches, or approximately 0.1 inches of the smaller cavities 46 at the shallow end and the deeper depth D4 within a range of 0.15 to 0.35 inches, or approximately 0.25 inches. As with the larger cavities 24, cavities 46 are tapered at each end by a taper angle α within a range of 1 to 5 degrees, or approximately 3 degrees.

FIGS. 12, 13, 14 show an alternatively configured tire in which protruding lugs 56 are circumferentially interspersed between the cavities 24 about the tread region. The lugs 56 are provided to enhance traction when the tire traverses packed ground surfaces that would otherwise cause the tire to slip. A packed surface will generally not fill the cavities 24 as the tire rotates, whereby reducing traction and making slippage more likely. By interspersing lugs 56 between the cavities 24, traction on packed surfaces is enhanced. As shown, at least one lug 56 is placed between adjacent cavities 24, however, it will be appreciated that more or fewer lugs may be employed if desired.

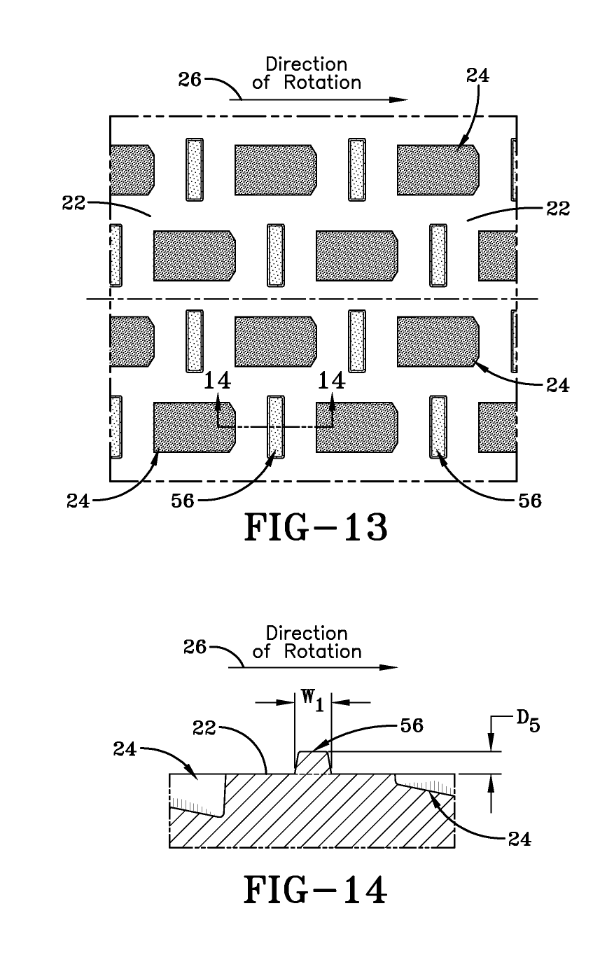

As shown in FIGS. 13, 14, each lug 56 is generally rectangular in section, having a width W1 between 0.25 and 0.625 inches; a height D5 of between 0.25 and 0.375 inches; and a length between 1 and 3 inches. The dimensions may be varied if desired to alter the gripping traction performances of the lugs 56. In yet another embodiment (not shown), the combination of cavities 24, lugs 56 (FIG. 12), and smaller cavities 46 (FIG. 10) along the tread region may be employed if desired.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An off-road tire tread for a tire having a circumferential ground-engaging tread region, the tread comprising:
a tread surface within the tread region;
a plurality of cavities extending into the tread surface, each cavity defined by sidewalls extending from the tread surface to an inclined bottom cavity surface, the inclined bottom cavity surface extending from a relatively deep leading cavity end to a relatively shallow trailing cavity end, and wherein the plurality of cavities are directionally oriented to operationally initiate contact with a ground surface at the leading cavity end.

2. The tire tread of claim 1, wherein each cavity has a substantially quadrilateral sectional configuration.

3. The tire tread of claim 1, wherein further comprising a plurality of the cavities each having leading and trailing cavity ends oriented in an opposite circumferential direction.

4. The tire tread of claim 1, wherein adjacent cavities have a centerline to centerline spacing between 3 and 5 inches.

5. The tire tread of claim 1, wherein each cavity has a depth at the leading cavity end recessed between 0.4 and 0.6 inches from the tread surface.

6. The tire tread of claim 5, wherein each cavity has a depth at the trailing cavity end recessed between 0.05 and 0.15 inches from the tread surface.

7. The tire tread of claim 6, wherein each cavity has a substantially quadrilateral sectional configuration and a pair of angled beveled surfaces at opposite corners of the cavity between a leading cavity surface and lateral cavity sidewalls.

8. The tire tread of claim 1, wherein the cavity sidewalls taper inward toward the cavity bottom surface at a taper angle between 1 and 5 degrees.

9. The tire tread of claim 8, wherein adjacent cavities have a centerline to centerline spacing between 3 and 5 inches.

10. The tire tread of claim 9, wherein each cavity has a depth at the leading cavity end recessed between 0.40 and 0.60 inches from the tread surface.

11. The tire tread of claim 10, wherein the bottom cavity surface has a depth at the trailing cavity end recessed between 0.05 and 0.15 inches from the tread surface.

12. The tire tread of claim 11, wherein each cavity has a substantially quadrilateral sectional configuration and a pair of angled beveled surfaces at opposite corners of the cavity between a leading cavity surface and lateral cavity sidewalls.

13. The tire tread of claim 1, wherein the tire tread further comprises a plurality of lug protrusion between the cavities.

14. The tire tread of claim 13, wherein each lug protrusion has a rectangular configuration in section having a width between 0.25 and 0.625 inches.

15. The tire tread of claim 13, wherein each lug protrusion extends from the tread surface to a height of between 0.25 and 0.375 inches.

16. The tire tread of claim 15, wherein each lug protrusion has a length between 1 and 3 inches.

17. The tire tread of claim 16, wherein the cavity sidewalls taper inward toward the cavity bottom surface at a taper angle between 1 and 5 degrees.

18. The tire tread of claim 17, wherein each cavity has a depth at the leading cavity end between 0.4 and 0.6 inches.

19. The tire tread of claim 18, wherein the bottom cavity surface intersects the tread surface at the cavity trailing end.

20. The tire tread of claim 19, wherein each cavity has a substantially quadrilateral sectional configuration and a pair of angled beveled surfaces at opposite corners of the cavity between a leading cavity surface and lateral cavity sidewalls.
